(19) United States
(12) Patent Application Publication
(10) Pub. No.: US 2007/0222908 A1
(43) Pub. Date: Sep. 27, 2007

(54) Thin film transistor substrate, display panel having the same and method of manufacturing the same

(76) Inventors: Joo-Han Kim, Gyeonggi-do (KR); Beom-Seok Cho, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/701,614

(22) Filed: Feb. 2, 2007

(30) Foreign Application Priority Data
Feb. 7, 2006 (KR) 2006-11425

(51) Int. Cl. G02F 1/136

(52) U.S. Cl. 349/43

(57) ABSTRACT

A thin film transistor (TFT) substrate that improves display quality and allows simpler manufacturing process is presented. The TFT substrate includes a substrate and a gate pattern, a gate-insulating layer, an active pattern, a data pattern, a protecting layer and a pixel electrode formed on the substrate. The gate pattern includes a gate line, a gate electrode connected to the gate line, and a conducting pattern. The gate-insulating layer covers the gate pattern. The active pattern is disposed on the gate-insulating layer. The data pattern is disposed on the active pattern and includes a data line that extends substantially perpendicularly to the gate line, a source electrode, and a drain electrode. The protecting layer covers the data pattern. The pixel electrode is disposed on the substrate and the gate-insulating layer. The conducting pattern serves to reduce a coupling capacitance between the pixel electrode and the data line.

### CROSS-REFERENCE TO RELATED APPLICATIONS

This application relies for priority upon Korean Patent Application No. 2006-11425 filed on Feb. 7, 2006, the content of which is herein incorporated by reference in its entirety.

### BACKGROUND OF THE INVENTION

1. Field of the Invention

The present invention relates to a thin film transistor substrate, a display panel having the thin film transistor substrate and a method of manufacturing the thin film transistor substrate. More particularly, the present invention relates to a thin film transistor substrate capable of improving a display quality and manufacturing productivity, a display panel having the thin film transistor substrate and a method of manufacturing the thin film transistor substrate.

2. Description of the Related Art

Today, liquid crystal display apparatuses are one of the most widely used types of flat display apparatuses. A liquid crystal display apparatus includes two substrates having electrodes and a liquid crystal layer between the substrates. The liquid crystal display apparatus rearranges liquid crystal molecules of the liquid crystal layer in response to a voltage applied to the electrodes to control the amount of light passing through the liquid crystal display apparatus.

The liquid crystal display apparatus includes a thin film transistor (TFT) serving as a switching device, a plurality of gate lines and a plurality of data lines. The gate lines and the data lines extend substantially perpendicularly to each other to define pixels arranged in a matrix configuration. Each of the pixels includes a pixel electrode.

During the operation of a liquid crystal display apparatus, an image signal transferred by each of the data lines is applied to one of the pixel electrodes in one row through the TFT. The pixel electrode maintains a floating state until a next image signal is applied to the pixel electrode. However, an image signal for a pixel electrode in the next row is applied to the data line, changing the voltage level of the pixel electrode in the floating state. When this happens, an undesired image appears on the liquid crystal display apparatus. The level of the image distortion is proportional to the coupling capacitance formed between the pixel electrode and the data line.

In order to reduce the coupling capacitance, a conducting pattern is formed under the data line to generate an electric field between the pixel electrode and the conducting pattern and between the data line and the conducting pattern. When a coupling capacitance between the data line and the pixel electrode is reduced, the data line and the pixel electrode may be disposed relatively adjacent to each other. Thus, the opening ratio increases as well as the transmitting ratio.

However, the conducting pattern must be formed from a different layer as the pixel electrode for this. Thus, the above-mentioned structure is formed through a 4-mask process. The 4-mask process increases the cost for masks and the number of process steps such as depositing a film layer, cleaning, coating a photoresist, exposing, developing, etching, stripping, etc. As a result, the manufacturing cost increases and the yield decreases.

### SUMMARY OF THE INVENTION

The present invention provides a thin film transistor substrate capable of improving a display quality and manufacturing productivity.

The present invention also provides a display panel having the above-mentioned thin film transistor substrate.

The present invention also provides a method of manufacturing the thin film transistor substrate.

In one aspect, the present invention is a thin film transistor substrate that includes a substrate, a gate pattern, a gate-insulating layer, an active pattern, a data pattern, a protecting layer and a pixel electrode. The gate pattern is disposed on the substrate and includes a gate line, a gate electrode connected to the gate line and a conducting pattern. The gate-insulating layer covers the gate pattern. The active pattern is disposed on the gate-insulating layer. The data pattern is disposed on the active pattern and includes a data line that extends substantially perpendicularly to the gate line, a source electrode, and a drain electrode. The protecting layer covers the data pattern. The pixel electrode is spaced apart from the conducting pattern and is disposed on the substrate and the gate-insulating layer.

In another aspect, the present invention is a display panel that includes a first substrate, a second substrate and a liquid crystal layer between the first substrate and the second substrate. The first substrate includes a gate pattern, a conducting pattern, a gate-insulating layer, an active pattern, a data pattern, a protecting layer and a pixel electrode. The conducting pattern is disposed on the same layer as the gate pattern. The gate-insulating layer covers the gate pattern and the conducting pattern. The active pattern is disposed on the gate-insulating layer. The data pattern is disposed on the active pattern and includes a data line that extends substantially perpendicularly to the gate line. The protecting layer covers the data pattern. The pixel electrode includes a first portion disposed on substantially the same layer as the conducting pattern and a second portion disposed on a different layer from the conducting pattern.

In still another aspect, the present invention is a method of manufacturing a thin film transistor substrate. The method entails forming a gate pattern including a gate line, a gate electrode electrically connected to the gate line and a conducting pattern on a substrate. A gate-insulating layer covering the gate pattern is formed. An active pattern is formed on the gate-insulating layer. A data pattern including a data line that extends substantially perpendicularly to the gate line, a source electrode, and a drain electrode are formed on the active pattern. A protecting layer is formed to cover the data patternd. A pixel electrode is formed on the substrate and the gate-insulating layer.

The pixel electrode may be formed by forming a photoresist film on the protecting layer and partially exposing the photoresist film to light to form a photoresist pattern. The photoresist pattern may have a first portion and a second portion that is thinner than the first portion. The protecting layer and the gate-insulating layer may be etched by using the photoresist pattern as a mask to expose a portion of the substrate. The second portion of the photoresist pattern and some of the first portion of the photoresist pattern may be removed to expose a portion of the protecting layer. An exposed portion of the protecting layer may be removed to expose a portion of the gate-insulating layer. A pixel electrode may be formed on an exposed substrate, an exposed gate-insulating layer and a remaining photoresist pattern. The remaining photoresist pattern may be removed with the pixel electrode formed on the remaining photoresist pattern.

According to the above, the conducting pattern and the pixel electrode form an electric field to reduce a coupling capacitance between the pixel electrode and the data line. Thus, a display quality may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a thin film transistor substrate according to an exemplary embodiment of the present invention;

FIG. 2 is a cross-sectional view taken along the line I-I′ in FIG. 1;

FIGS. 3 to 7 are cross-sectional views illustrating a method of manufacturing the thin film transistor substrate illustrated in FIG. 2;

FIG. 8 is a cross-sectional view taken along the line II-III′ in FIG. 1;

FIG. 9 is a cross-sectional view illustrating a thin film transistor substrate according to another exemplary embodiment of the present invention;

FIG. 10 is a cross-sectional view illustrating a half-tone mask according to another exemplary embodiment of the present invention;

FIG. 11 is a cross-sectional view illustrating a half-tone mask according to another exemplary embodiment of the present invention; and

FIGS. 12 to 15 are cross-sectional views illustrating a process forming a pixel electrode according to another exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when a member or layer is referred to as being “on”, “connected to” or “coupled to” another member or layer, it can be directly on, connected or coupled to the other member or layer or intervening members or layers may be present. In contrast, when a member is referred to as being “directly on,” “directly connected to” or “directly coupled to” another member or layer, there are no intervening members or layers present. Like numbers refer to like members throughout. As used herein, the term “and/or” includes any and all combinations of one or more of the associated listed items.

It will be understood that, although the terms first, second, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the present invention.

Spatially relative terms, such as “beneath,” “below,” “lower,” “above,” “upper” and the like, may be used herein for ease of description to describe one member or feature's relationship to another member(s) or feature(s) as illustrated in the figures. It will be understood that the spatially relative terms are intended to encompass different orientations of the device in use or operation in addition to the orientation depicted in the figures. For example, if the device in the figures is turned over, members described as “below” or “beneath” other members or features would then be oriented “above” the other members or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, members, and/or components, but do not preclude the presence or addition of one or more other features, integers, steps, operations, members, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

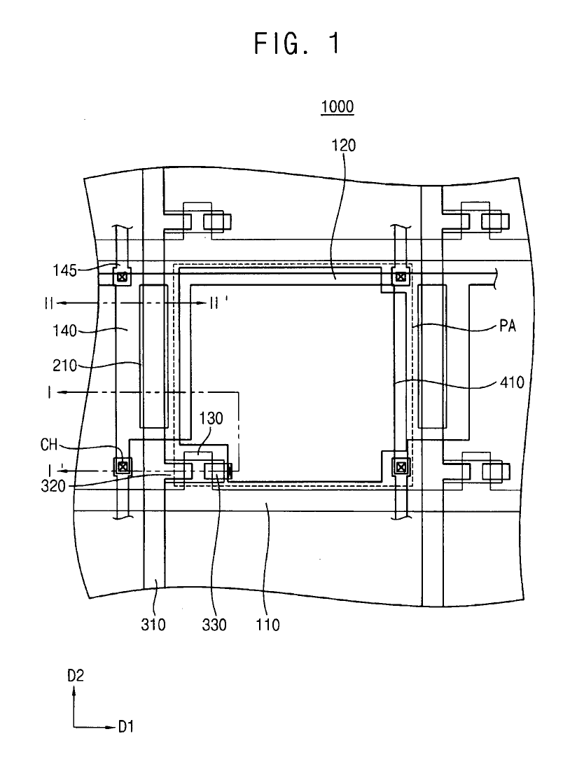

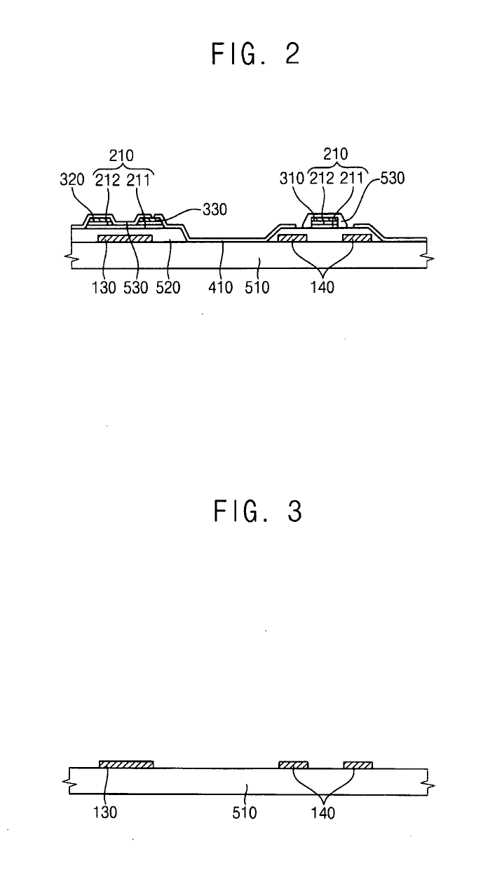

FIG. 1 is a plan view illustrating a thin film transistor (TFT) substrate according to an exemplary embodiment of the present invention. FIG. 2 is a cross-sectional view taken along the line I-I′ in FIG. 1.

Referring to FIGS. 1 and 2, a TFT substrate 1000 includes a substrate 510, a gate pattern 110, 120, 130, and 140 a data pattern 310, 320, and 330, an active pattern 210 and a pixel electrode 410. The TFT substrate 1000 may further include a gate-insulating layer 520 and a protecting layer 530.

The substrate 510 includes a transparent material capable of transmitting light. Examples of transparent materials that can be used for the substrate 510 may include glass, quartz, etc.

The gate pattern 110 120 130 and 140 includes a gate line 110, a storage pattern 120, a gate electrode 130 and a conducting pattern 140. The storage pattern 120 may be formed separately from the gate line 110. The gate electrode 130 extends from the gate line 110.

The conducting pattern 140 is disposed along a data line 310. A predetermined voltage is applied to the storage pattern 120. The storage pattern 120 is capacitively coupled to the pixel electrode 410 to maintain a pixel voltage applied to the pixel electrode 410 for a predetermined time. The conducting pattern 140 is disposed on the substrate 510, and may be spaced apart from the gate line 110 and the gate electrode 130. For example, the conducting pattern 140 may not be overlapped with the data line 310.

The conducting pattern 140 may be electrically connected to the storage pattern 120. Furthermore, the conducting pattern 140 may be electrically connected to a conducting pattern of an adjacent pixel through an overpass 145. The overpass 145 may be formed from substantially the same layer as the pixel electrode 410. The overpass 145 may be electrically connected to the conducting pattern 140 through a contact hole CH.

The TFT substrate 1000 may include an auxiliary conducting pattern in addition to the conducting pattern 140. The auxiliary conducting pattern may be positioned across the data line 310 from the conducting pattern 140, and may be adjacent to the data line 310. The conducting pattern 140 and the auxiliary conducting pattern may be symmetric with respect to the data line 310 in plan view, and both may extend parallel to the data line 310.

The date pattern 310, 320 and 330 includes the data line 310, a source electrode 320 and a drain electrode 330. The data line 310 crosses the gate line 110, and is electrically insulated from the gate line 110. A pixel area PA is defined by the gate line 110 and the data line 310.

The active pattern 210 includes a semiconductor pattern 211 and an ohmic contact pattern 212 formed on the semiconductor pattern 211. For example, the semiconductor pattern 211 includes an amorphous silicon (a-Si), and the ohmic contact pattern 212 includes an n⁺ amorphous silicon into which n type impurities are implanted at a high concentration (n⁺ a-Si). A central portion of the ohmic contact pattern 212 is removed to expose a portion of the semiconductor pattern 211.

A thin film transistor (TFT) includes the gate electrode 310, the source electrode 320 and the drain electrode 330. The drain electrode 330 is spaced apart from the source electrode 320, and is electrically connected to the pixel electrode 410. The TFT performs a switching operation in response to a gate signal applied to the gate electrode 330 via the gate line 110 so that the TFT provides a data signal to the pixel electrode 410.

The gate-insulating layer 520 is formed on the substrate 510 to cover the gate pattern 110, 120, 130 and 140. The gate-insulating layer 520 may include a silicon nitride (SiNx) or a silicon oxide (SiOx).

The protecting layer 530 is disposed on the substrate 510 to cover the TFT and the date pattern 310, 320 and 330, and exposes a portion of the drain electrode 330. The pixel electrode 410 covers a portion of the drain electrode 330. Particularly, the pixel electrode 410 may make contact with a side portion of the drain electrode 330. The pixel electrode 410 may be formed on the substantially same layer as the conducting pattern 140. Alternatively, the pixel electrode 410 may covers a portion of the gate-insulating layer 520. In one embodiment, a portion of the pixel electrode 410 may be disposed on the gate-insulating layer 520 covering the conducting pattern 140, and another portion of the pixel electrode 410 may be disposed on the substrate 510.

The pixel electrode 410 includes a transparent conducting material capable of transmitting light. For example, the pixel electrode 410 may include indium zinc oxide (IZO), indium tin oxide (ITO) or amorphous indium tin oxide (a-ITO). The pixel electrode 410 is electrically connected to the drain electrode 330 of the TFT

A first mask, a second mask and a third mask are used for manufacturing the TFT substrate 1000. The first mask is used for forming the gate pattern 110, 120, 130 and 140. The second mask is used for forming the active pattern 210 and the date pattern 310, 320 and 330. The third mask is used for forming the protecting layer 530. The pixel electrode 410 is formed by lifting off a photoresist film used for forming the protecting layer 530. The lifting off of a photoresist film will be described more fully hereinafter.

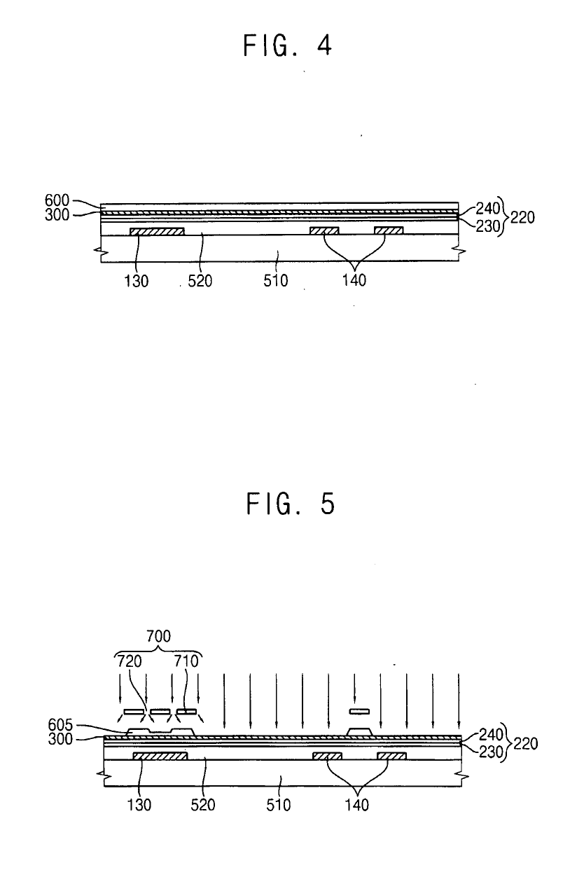

FIGS. 3 to 7 are cross-sectional views illustrating a method of manufacturing the TFT substrate illustrated in FIG. 2.

Referring to FIG. 3, a first metal layer is formed on a substrate 510, and a gate pattern 110, 120, 130 and 140 is formed using a first mask that has a predetermined pattern. The first metal layer may include chrome, a chrome alloy, etc. The first metal layer is deposited on the substrate 510 through a sputtering method, etc. A photoresist film is formed on the first metal layer. Thereafter, the photoresist film is exposed to light through the first mask that has the pattern corresponding to the gate pattern 110, 120, 130 and 140, and the photoresist film is developed. Thereafter, the first metal layer is etched, and a remaining photoresist film is removed to form the gate pattern 110, 120, 130 and 140. Since the following process of forming a pattern using a mask is substantially the same as the process of forming the gate pattern that is just described, any redundant explanation will be omitted.

Referring to FIG. 4, after forming the gate pattern 110, 120, 130 and 140 on the substrate 510, a gate-insulating layer 520, an active layer 220 including a semiconductor layer 230 and an ohmic contact layer 240, a second metal layer 300 for forming a data pattern and a photoresist film 600 are formed on the substrate 510, in sequence.

Referring to FIG. 5, the second mask 700 is positioned on the photoresist film 600, and the photoresist film 600 is exposed to light and developed. Particularly, the second mask 700 includes a slit 720 to partially-expose the photoresist film 600. Light that passes through the slit 720 is diffracted so that the exposed portion of the photoresist film 600 under the slit is relatively smaller than the portion of the photoresist film 600 that would be exposed if the second mask 700 were fully opened. Thus, the thickness of the developed photoresist film 605 has a variation. Particularly, the developed photoresist film 605 under the slit 720 is thinner than the portion of the developed photoresist film 605 that is not exposed to light.

Referring to FIGS. 5 and 6, the second metal layer 300 and the active layer 220 are etched using the developed photoresist film 605 as an etching mask, and the developed photoresist film 605 is etched. Particularly, the developed photoresist film 605 under the slit 720 is removed so that a portion 607 of the developed photoresist film 605 for forming a source electrode and a drain electrode remains.

Referring to FIGS. 6 and 7, the remaining portion of the second metal pattern 300 is etched using the portion 607 of the developed photoresist pattern as an etching mask so that the source electrode 320 and the drain electrode 330 are formed. Thereafter, the portion 607 of the developed photoresist pattern is removed, and a remaining ohmic contact layer 240 is etched to expose a portion of the semiconductor pattern 211 using the source electrode 320 and the drain electrode 330 as an etching mask so that a TFT is completed. Thereafter, a protecting layer 530 is formed on the substrate having the TFT. For example, the protecting layer 530 may include a silicon nitride (SiNx), and may be deposited through a plasma enhanced chemical vapor deposition (PECVD) method.

Thereafter, a portion of the protecting layer 530 is removed using the third mask, and a pixel electrode is formed. As a result, a TFT substrate that is substantially the same as the TFT substrate illustrated in FIG. 2. is completed.

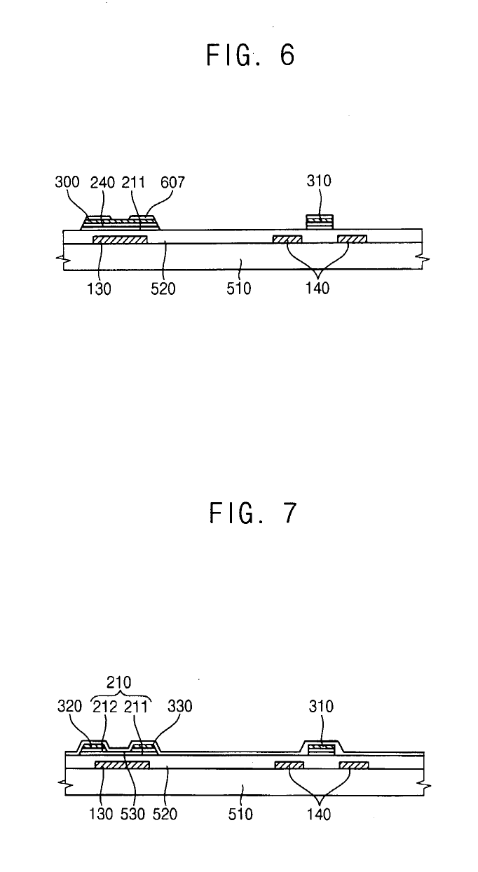

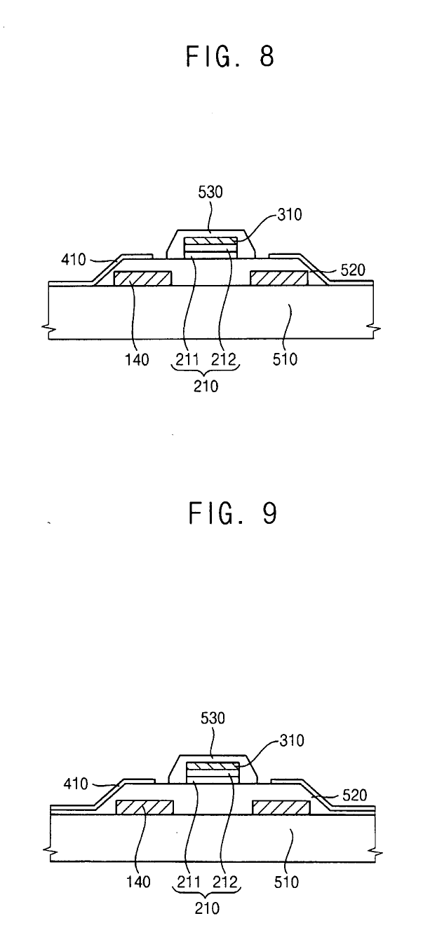

FIG. 8 is a cross-sectional view taken along the line II-II′ in FIG. 1. FIG. 9 is a cross-sectional view illustrating a TFT substrate according to another exemplary embodiment of the present invention.

Referring to FIGS. 1 and 8, a portion of the pixel electrode 410 is disposed on the gate-insulating layer 520 that is on the substrate 510, and a remaining portion of the pixel electrode 410 extends toward an opened portion of the gate-insulating layer 520 to be disposed on the substrate 510. One of the conducting patterns 140 is adjacent to a first side of the data line 310, and the remaining one of the conducting patterns 140 is adjacent to a second side of the data line 310 that is opposite to the first side. The conducting patterns 140 may be substantially symmetric with respect to the data line 310. For example, the conducting pattern 140 may not be overlapped with the data line 310. Alternatively, the conducting pattern 140 may lie over a portion of the data line 310. Alternatively, a side of the conducting pattern 140 adjacent to the data line 310 may correspond to a side of the data line 310 adjacent to the conducting pattern 140. The pixel electrode 410 may lie over a portion of the conducting pattern 140. Alternatively, a side of the pixel electrode 410 adjacent to the data line 310 may correspond to a side of the conducting pattern 140 adjacent to the pixel electrode 410.

The conducting pattern 140 may serve as a light blocking pattern. Particularly, the conducting pattern 140 prevents light from leaking in an area adjacent to the data line 310 or the gate line 210. Thus, a width of a black matrix (not shown) formed on a color filter substrate (not shown) may decrease.

Since a voltage variation is caused by a coupling capacitance between the data line 310 and the pixel electrode 410, a brightness difference is displayed on a screen of a display apparatus. The brightness difference is relatively greater at a low gray scale, and is arranged in a vertical direction. The above-mentioned problem may be prevented and/or reduced by the conducting pattern 140 of the present invention. A first coupling capacitance C1 between the conducting pattern 140 and the pixel electrode 410 reduces a second coupling capacitance C2 between the pixel electrode 410 and the data line 310.

The distance between the conducting pattern 140 and the pixel electrode 410 is smaller than the distance between the pixel electrode 410 and the data line 310. Since a coupling capacitance inversely proportional to distance between electrodes, the first coupling capacitance C1 is greater than the second coupling capacitance C2. Thus, although the second coupling capacitance C2 varies, a variation of a total coupling capacitance is relatively small. Therefore, a stitch defect may be reduced.

The conducting pattern 140 may be disposed in various arrangements. The conducting pattern 140 may be disposed under a gap between the data line 310 and the pixel electrode 410. The width of the conducting pattern 140 is no less than the width of the gap between the data line 310 and the pixel electrode 410. Two adjacent conducting patterns 140 may be disposed substantially symmetrically with respect to the data line 310.

Referring to FIG. 9, a thin film transistor substrate is substantially the same as the thin film transistor substrate illustrated in FIG. 8, except that a pixel electrode 410 is disposed on a gate-insulating layer 520 having a relatively small thickness. The pixel electrode 410 in FIG. 8 is directly disposed on the substrate 510. However, the pixel electrode 410 in FIG. 9 is disposed on the gate-insulating layer 520 having a relatively small thickness. As the above, a portion of the gate-insulating layer is not etched and thus remains on the substrate 510.

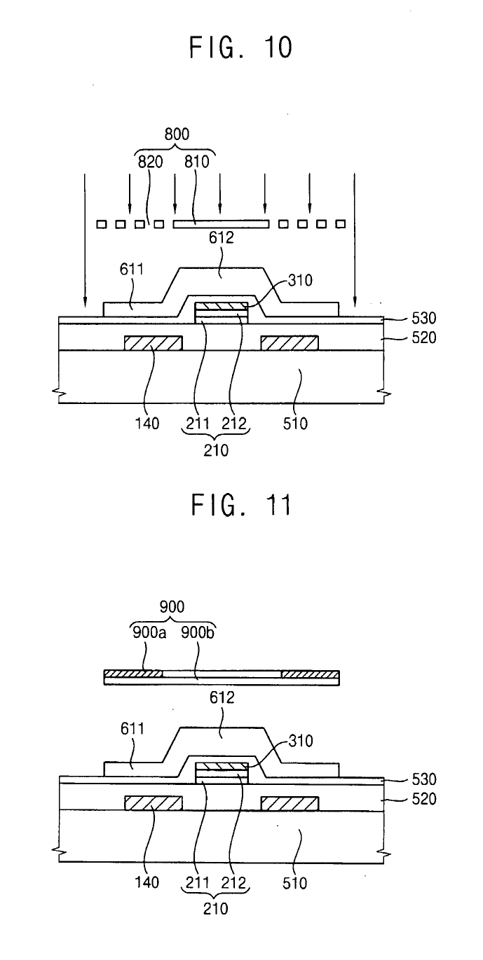

FIG. 10 is a cross-sectional view illustrating a half-tone mask according to another exemplary embodiment of the present invention. Referring to FIG. 10, a photoresist film is disposed on a protecting layer 530. A mask 800 having a slit 820 is disposed on the photoresist film, and the photoresist film is exposed to light through the mask 800 and is developed. A portion 611 of the photoresist film that is exposed to light through the slit 820 is thinner than a portion 612 of the photoresist film that is not exposed to light.

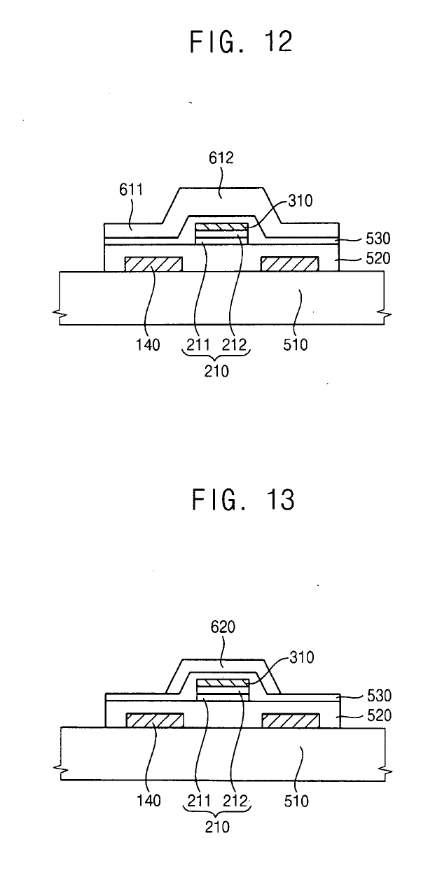

FIG. 11 is a cross-sectional view illustrating a half-tone mask according to another exemplary embodiment of the present invention. Referring to FIG. 11, a photoresist film is disposed on a protecting layer 530. A mask 900 having an absorbing-transmitting portion 900a is disposed on the photoresist film, and the photoresist film is exposed to light through the mask 900 and developed. The amount of light passing through the absorbing-transmitting portion 900a is relatively small. Thus, the portion 611 of the photoresist film exposed to the light through the absorbing-transmitting portion 900a is thinner than the portion 612 of the photoresist film that is not exposed to light.

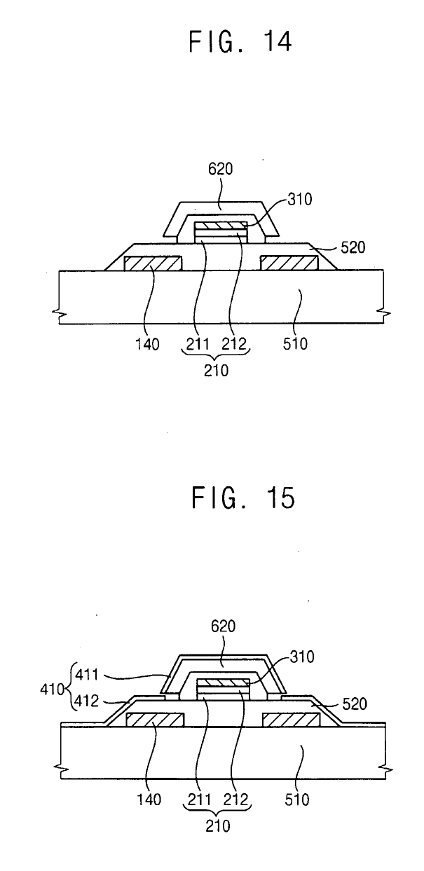

FIGS. 12 to 15 are cross-sectional views illustrating a process forming a pixel electrode according to another exemplary embodiment of the present invention.

Referring to FIG. 12, a gate-insulating layer 520 and a protecting layer 530 are etched using a photoresist pattern as a mask. The gate-insulating layer 520 is partially removed to remain on the substrate 510 at a uniform thickness.

Referring to FIGS. 12 and 13, the photoresist pattern is etched. The photoresist pattern may be etched by an ashing process using a plasma. The photoresist pattern has a thickness variation before the etching. The partially exposed portion 611 of the photoresist pattern is removed through the ashing process. When the photoresist pattern is etched, the partially exposed portion 611 of the photoresist pattern is removed, and the non-exposed portion 612 of the photoresist pattern becomes thinner. Thus, a lower portion of the non-exposed portion 612 remains on the protecting layer 530 in a thinned form. The portion of the protecting layer 520 corresponding to the partially exposed portion 611 is exposed.

Referring to FIG. 14, the protecting layer 530 and the gate-insulating layer 520 are etched. The protecting layer 530 may be etched beneath a remaining photoresist pattern 620 so that an undercut is formed under the remaining photoresist pattern 620.

The undercut may be formed through a following method. The protecting layer 530 is isotropically etched by a wet etching process. When the protecting layer 530 is over-etched by the wet etching process, the protecting layer 530 becomes etched under the remaining photoresist pattern 620 to form the undercut.

Alternatively, after the protecting layer 530 is anisotropically etched by a dry etching process, the protecting layer 530 is isotropically etched by wet etching to form the undercut.

Referring to FIG. 15, the transparent conductive layer 410 is disposed on the remaining photoresist film 620, the gate-insulating layer 520 and the substrate 510. A first portion 411 of the transparent conductive layer 410 on the remaining photoresist film 620 is not connected to a second portion 412 of the transparent conductive layer 410 on the gate-insulating layer 520 due to the undercut. The remaining photoresist film 620 and the second portion 412 of the transparent conductive layer 410 on the remaining photoresist film 620 are removed through the lift-off process.

An edge portion of the gate-insulating layer 520 may be slanted at a predetermined angle. Alternatively, the gate-insulating layer 520 may have a uniform thickness.

The lift-off process includes patterning a photoresist film, depositing a layer on the patterned photoresist film and removing the patterned photoresist film and a portion of the layer on the patterned photoresist film. In FIG. 15, the transparent conductive layer 410 may be patterned using the lift-off process so that an etching process may be omitted. Particularly, the first portion 411 of the transparent conductive layer 410 on the remaining photoresist pattern 620 is removed through removing the remaining photoresist pattern 620 so that the second portion 412 of the transparent conductive layer 410 that is not disposed on the remaining photoresist pattern 620 remains to form a pixel electrode. After the lift-off process, the TFT substrate illustrated in FIG. 8 or 9 is completed.

According to the above, a conducting pattern including a material substantially the same as a gate line is interposed between a data line and a pixel electrode. The conducting pattern and the pixel electrode form an electric field to reduce a coupling capacitance between the pixel electrode and the data line. Thus, display quality may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A thin film transistor (TFT) substrate comprising:
a substrate;
a gate pattern on the substrate, the gate pattern including a gate line, a gate electrode electrically connected to the gate line, and a conducting pattern;
a gate-insulating layer covering the gate pattern;
an active pattern on the gate-insulating layer;
a data pattern on the active pattern, and the data pattern including a data line that extends substantially perpendicularly to the gate line, a source electrode, and a drain electrode, the source and drain electrodes being on the gate electrode;
a protecting layer covering the data pattern; and
a pixel electrode on the substrate and the gate-insulating layer.

2. The TFT substrate of claim 1, wherein the pixel electrode comprises a first portion on the substrate and a second portion on the gate-insulating layer covering the conducting pattern.

3. The TFT substrate of claim 1, wherein the pixel electrode comprises a first portion having a substantially same height as the conducting pattern and a second portion on the gate-insulating layer, wherein height is a distance from the substrate.

4. The TFT substrate of claim 3, wherein the conducting pattern has a first width and extends in a direction that is substantially parallel to the data line.

5. The TFT substrate of claim 4, wherein the conducting pattern is adjacent to the data line and the pixel electrode.

6. The TFT substrate of claim 5, wherein the first width of the conducting pattern is greater than a gap between the data line and the pixel electrode.

7. The TFT substrate of claim 5, wherein a side of the pixel electrode adjacent to the data line corresponds to a side of the conducting pattern adjacent to the pixel electrode.

8. The TFT substrate of claim 5, wherein the pixel electrode overlaps with at least a portion of the conducting pattern.

9. The TFT substrate of claim 4, further comprising an auxiliary conducting pattern, wherein the conducting pattern is adjacent to a first side of the data line and the auxiliary conducting pattern is adjacent to a second side of the data line that is opposite to the first side.

10. The TFT substrate of claim 9, wherein the conducting pattern and the auxiliary conducting pattern are substantially symmetric with respect to the data line.

11. The TFT substrate of claim 3, wherein the conducting pattern is electrically connected to the gate line.

12. The TFT substrate of claim 3, wherein the conducting pattern comprises a plurality of sub conducting patterns spaced apart from each other.

13. The TFT substrate of claim 3, wherein the conducting pattern comprises a plurality of sub conducting patterns electrically insulated from each other.

14. A display panel comprising:
a first substrate having:
a gate pattern and a conducting pattern disposed on the same layer,
a gate-insulating layer covering the gate pattern and the conducting pattern,
an active pattern disposed on the gate-insulating layer to overlap with the gate electrode,
a data pattern disposed on the active pattern and including a data line that extends substantially perpendicularly to the gate line,
a source electrode,
a drain electrode,
a protecting layer covering the data pattern, and
a pixel electrode having a first portion disposed on substantially the same layer as the conducting pattern and a second portion disposed on a different layer;
a second substrate positioned substantially parallel to the first substrate; and
a liquid crystal layer interposed between the first substrate and the second substrate.

15. The display panel of claim 14, wherein the second portion of the pixel electrode is disposed on the gate-insulating layer covering the conducting pattern.

16. The display panel of claim 15, further comprising an auxiliary conducting pattern, wherein the conducting pattern is adjacent to a first side of the data line and the auxiliary conducting pattern is adjacent to a second side of the data line, which is in opposite to the first side, and each of the conducting pattern and the auxiliary conducting pattern extending in a direction substantially parallel to the data line.

17. A method of manufacturing a thin film transistor substrate, comprising:
forming a gate pattern comprising a gate line, a gate electrode electrically connected to the gate line and a conducting pattern on a substrate;
forming a gate-insulating layer covering the gate pattern;
forming an active pattern on the gate-insulating layer and a data pattern comprising a data line extending perpendicularly to the gate line, a source electrode and a drain electrode on the active pattern;
forming a protecting layer covering the data pattern; and
forming a pixel electrode on the substrate and the gate-insulating layer.

18. The method of claim 17, wherein the pixel electrode comprises a first portion disposed on the same layer as the conducting pattern and a second portion disposed on a different layer than the conducting pattern.

19. The method of claim 18, wherein the conducting pattern extends in a direction that is substantially parallel to the data line, and is adjacent to the pixel electrode and the data line.

20. The method of claim 17, wherein forming the pixel electrode comprises:
forming a photoresist film on the protecting layer;
partially-exposing the photoresist film to light to form a photoresist pattern having a first portion and a second portion that is thinner than the first portion;
etching the protecting layer and the gate-insulating layer by using the photoresist pattern as a mask to expose a portion of the substrate;
removing the second portion of the photoresist pattern and some of the first portion of the photoresist pattern to expose a portion of the protecting layer;
removing an exposed portion of the protecting layer to expose a portion of the gate-insulating layer;
forming a pixel electrode on an exposed substrate, an exposed gate-insulating layer and a remaining photoresist pattern; and
removing the remaining photoresist pattern and the pixel electrode formed on the remaining photoresist pattern.

21. The method of claim 20, wherein removing the second portion of the photoresist pattern and some of the first portion of the photoresist pattern is performed by an ashing process.

22. The method of claim 20, wherein after removing an exposed portion of the protecting layer, a remaining protecting layer has an undercut gap between the remaining photoresist pattern and the protecting layer.

23. The method of claim 20, wherein partially-exposing the photoresist layer comprises using a mask having a slit.

24. The method of claim 20, wherein partially-exposing the photoresist layer comprises using a mask having an absorbing-transmitting portion.
